(19) United States
(12) Patent Application Publication
(10) Pub. No.: US 2026/0078637 A1
(43) Pub. Date: Mar. 19, 2026

(54) WINDOW SCREEN ASSEMBLY WITH DUAL SIDE EXPANDERS TO REDUCE MEASUEMENTS AND ACCURACY NEEDED FOR SELECTION/INSTALLATION

(71) Applicant: The RiteScreen Company, LLC, Elizabethville, PA (US)

(72) Inventors: Steven E. Ulsh, Elizabethville, PA (US); John C. St. Clair, Ashville, PA (US)

(21) Appl. No.: 19/396,468

(22) Filed: Nov. 21, 2025

Related U.S. Application Data
(63) Continuation of application No. 18/131,378, filed on Apr. 6, 2023, now Pat. No. 12,503,912.
(60) Provisional application No. 63/327,876, filed on Apr. 6, 2022.

(51) Int. Cl. E06B 9/52

(52) U.S. Cl. CPC E06B 9/522; E06B 2009/527

(57) ABSTRACT

A screen assembly is configured to permit installation in various different sized windows having various different window socket dimensions. The screen assembly includes: a frame, a mesh secured to the frame, at least one expander member, and a biasing member, which may be a spring. The expander member is mounted to a first side of the frame, and configured to slide with respect to the frame between a fully retracted position, a fully extended position, and a plurality of intermediate positions. The biasing member biases the expander member toward the fully extended position. The range of sliding distances for the expander member relative to the fixed frame portion thereby provides a variable lateral extent for the screen assembly permitting its installation into various different sized windows having various different window socket dimensions.

### CROSS-REFERENCES

This application is a continuation of, and claims a benefit of priority under 35 U.S.C. § 120 from, U.S. patent application Ser. No. 18/131,378, filed Apr. 6, 2023, entitled “Window Screen Assembly With Dual Side Expanders To Reduce Measurements And Accuracy Needed For Selection/Installation,” which claims priority on U.S. Provisional Patent Application Ser. No. 63/327,876, filed on Apr. 6, 2022, the disclosures of which are incorporated herein by reference.

### FIELD OF THE INVENTION

The subject technology relates generally to improvements in a removable screen that may be used for windows and doors, and more particularly to an improved screen assembly that can be selected for installation into an existing window (or door) socket with fewer measurements, which also need not be as accurate.

### BACKGROUND OF THE INVENTION

Screens that are used in homes and apartments are typically constructed to utilize a rectangular frame (where the window is rectangular shaped), and the screen's frame has a groove cut into t she inward facing side of the frame, with the groove circling around the entire periphery of that side of the frame. A mesh material is typically cut to be slightly larger than the extent of the peripheral groove, and is then overlaid onto that side of the frame. A flexible vinyl “spline” is next overlaid on the screen above the groove, and is pressed into the groove, forcing and retaining the mesh therein. The diameter of the spline, typically 3.6 mm to 4.8 mm, is sized to be retained within the groove, in combination with the thickness of mesh used, in a friction fit. Any protruding excess mesh material may then be trimmed away.

This screen construction must have the vertical and horizontal extent of the rectangular frame be sized to fit the particular dimensions of the master frame of the window or door. Almost all new windows are sold with a screen that is specifically manufactured to fit the corresponding opening in the master frame of that window.

However, very often the current owner purchased his/her home from someone who had removed and discarded a screen that was damaged or which became damaged while being stored indoors during the winter when it may have been replaced by a storm window, and the current owner then needs to purchase a new replacement screen. Additionally, many older homes have windows that did not originally have a corresponding screen, and to provide ventilation without admitting bugs, the owner desires to add a new screen to the old window.

Hiring a professional to come out to a home to measure, build, and install custom replacement screens is very expensive. Moreover, most homeowners are not comfortable with handling a tape measure to try to accurately measure the lateral extent of the opening in the master window frame, while furthermore accounting for the depth of the socket that receives the frame of the screen. Even professionals can make mistakes at such measurements, hence the proverb in the construction industry of measure twice, cut once.

The herein disclosed screen with dual side expanders provides a significant improvement over prior art screens, enabling a homeowner to purchase one that is close to the exact master window frame dimensions, but which nonetheless adjusts to fit without needing to measure the openings carefully, and which provide a clean custom fit look.

The herein disclosed screen assembly with dual side expanders may also be used as a universal screen for installation into a range of different window sizes for new fenestration products.

### OBJECTS OF THE INVENTION

It is an object of the invention to provide a screen assembly that may be easily selected, and installed into, the master frame of an old window.

It is another object of the invention to provide a screen that may be purchased for installation into an existing master frame of a window, without having to accurately measure the frame's opening and socket depth.

It is a further object of the invention to provide a screen that may be purchased for installation into a variety of different sized sockets in an existing master frame of a window.

It is another object of the invention to provide a window screen that adjusts to fit a master window frame, and which provide a uniform appearance on the interior and exterior, being centered in the socket.

It is yet a further object of the invention to provide a screen assembly with dual side expanders may also permit universal installation into a range of different socket sizes in a plurality of new fenestration products.

Further objects and advantages of the invention will become apparent from the following description and claims, and from the accompanying drawings.

### BRIEF DESCRIPTION OF DRAWINGS

The description of the various example embodiments is explained in conjunction with the following appended drawings.

FIG. 1 is a perspective view of a first embodiment of a screen assembly, as disclosed herein, having dual side expanders, shown installed in a portion of the master frame of a window.

FIG. 2 is a perspective view showing a portion of the screen assembly of FIG. 1, shown prior to being installed in one side of the master frame of the window.

FIG. 3 is a perspective view showing a second embodiment of a screen assembly, as disclosed herein, having dual side expanders.

FIG. 4 is a partially exploded view of the screen assembly of FIG. 3, shown prior to one of the expander members being slidably attached to the frame of the screen.

FIG. 5 is a perspective view showing a third embodiment of a screen assembly, as disclosed herein, having dual side expanders, only one of which includes a handle for installation and removal from a master window frame.

FIG. 6 is an exploded view showing the screen assembly of FIG. 5, shown prior to one of the expanders being slidably attached to the frame of the screen.

FIG. 7 is a front view of a master window frame, showing features that typically need to be measured accurately in order to be able to construct a suitably sized screen for the window.

FIG. 7A is a first cross-sectional view taken through the master window frame of FIG. 7.

FIG. 7B is a second cross-sectional view taken through the master window frame of FIG. 7.

FIG. 7C is a third cross-sectional view taken through the master window frame of FIG. 7.

FIG. 8 is the front view of the master window frame shown in FIG. 7, but showing the features that need to be measured in order to be able to construct a suitably sized screen for a window, only one of which needs to be measured accurately.

FIG. 9 is a first cross-sectional view taken through the master window frame of FIG. 8.

FIG. 10A is a second cross-sectional view taken through the master window frame of FIG. 8.

FIG. 10B is a third cross-sectional view taken through the master window frame of FIG. 8.

FIG. 11 is a front view showing another embodiment of a screen assembly, as disclosed herein, having dual side expanders.

FIG. 12 is an enlarged detail view showing the right side of the screen assembly of FIG. 11.

FIG. 12A is the detail view of FIG. 12, but which instead illustrates use of a compression spring for biasing of the expander member.

FIG. 13 is a top view of the right side of the screen assembly shown in FIG. 12.

FIG. 14 is the front view of FIG. 11, but shown after a force has been applied to each of the dual expanders, to position each in a fully retracted position, in which the springs are compressed.

FIG. 15 shows the screen assembly of FIG. 11 just prior to being installed in the master window frame of FIG. 8, with both expander members actuated by a force into the fully retracted position.

FIG. 16 shows the screen assembly of FIG. 11 after being installed in the master window frame of FIG. 8;

FIG. 17 is a front view showing yet another embodiment of a screen assembly, as disclosed herein, having dual side expanders and a dual handle arrangement.

FIG. 17A is a cross-sectional view through one side of the screen assembly of FIG. 17, with the expander shown in the fully extended position.

FIG. 18 is a cross-sectional view through one side of the screen assembly of FIG. 17, with the expander shown in the fully retracted position.

FIG. 19 shows an expander of the screen assembly of FIG. 17, which is not a closed cross-sectional shape and has an opening, permitting the expander to be slidably mounted onto the frame with a portion of the frame being received through the opening, until positioned as seen in FIG. 17A.

FIG. 20A and FIG. 2B show a cross-sectional view through the screen assembly of FIG. 17, for one particular screen size embodiment, being shown with the springs in the expanded state in FIG. 20A and with the springs in the collapsed state in FIG. 20B.

FIG. 21 shows a cross-sectional view of a portion of a prior art master window frame.

### DETAILED DESCRIPTION OF THE INVENTION

As used throughout this specification, the word “may” is used in a permissive sense (i.e., meaning having the potential to, or being optional), rather than a mandatory sense (i.e., meaning must), as more than one embodiment of the invention may be disclosed herein. Similarly, the words “include”, “including”, and “includes” mean including but not limited to.

The phrases “at least one”, “one or more”, and “and/or” may be open-ended expressions that are both conjunctive and disjunctive in operation. For example, each of the expressions “at least one of A, B and C”, “one or more of A, B, and C”, and “A, B, and/or C” herein means all of the following possible combinations: A alone; or B alone; or C alone; or A and B together; or A and C together; or B and C together; or A, B and C together.

Also, the disclosures of all patents, published patent applications, and non-patent literature cited within this document are incorporated herein in their entirety by reference. However, It is noted that the citing of any reference within this disclosure, i.e., any patents, published patent applications, and non-patent literature, is not an admission regarding a determination as to its availability as prior art with respect to the herein disclosed and claimed apparatus/method.

Furthermore, any reference made throughout this specification to “one embodiment” or “an embodiment” means that a particular feature, structure or characteristic described in connection therewith is included in at least that one particular embodiment. Thus, the appearances of the phrases “in one embodiment” or “in an embodiment” in various places throughout this specification are not necessarily all referring to the same embodiment. Therefore, the described features, advantages, and characteristics of any particular aspect of an embodiment disclosed herein may be combined in any suitable manner with any of the other embodiments disclosed herein.

Additionally, any approximating language, as used herein throughout the specification and claims, may be applied to modify any quantitative or qualitative representation that could permissibly vary without resulting in a change in the basic function to which it is related. Accordingly, a value modified by a term such as “about” is not to be limited to the precise value specified, and may include values that differ from the specified value in accordance with design variations described in the specification, as well as applicable case law. Also, in at least some instances, a numerical difference provided by the approximating language may correspond to the precision of an instrument that may be used for measuring the value. A numerical difference provided by the approximating language may also correspond to a manufacturing tolerance associated with production of the aspect/feature being quantified (see e.g., Ex Parte Ollmar, Appeal No. 2014-006128 (PTAB 2016)). Furthermore, a numerical difference provided by the approximating language may also correspond to an overall tolerance for the aspect/feature that may be derived from variations resulting from a stack up (i.e., the sum) of a multiplicity of such individual tolerances.

Similarly, the term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Any use of a friction fit (i.e., an interface fit) between two mating parts described herein indicates that the opening (e.g., a hole) is smaller than the part received therein (e.g., a shaft), which may be a slight interference in one embodiment in the range of 0.0001 inches to 0.0003 inches, or an interference of 0.0003 inches to 0.0007 inches in another embodiment, or an interference of 0.0007 inches to 0.0010 inches in yet another embodiment, or a combination of such ranges. Other values for the interference may also be used in different configurations (see e.g., “Press Fit Engineering and Design Calculator,” available at: www.engineersedge.com/calculators/machine-design/press-fit/press-fit-calculator.htm).

Any described use of a clearance fit indicates that the opening (e.g., a hole) is larger than the part received therein (e.g., a shaft), enabling the two parts to move (e.g. to slide and/or rotate) when assembled, where the gap between the opening and the part may depend upon the size of the part and the type of clearance fit-i.e., loose running, free running, easy running, close running, and sliding (e.g., for a 0.1250 inch shaft diameter the opening may be 0.1285 inches for a close running fit, and may be 0.1360 inches for a free running fit; for a 0.5000 inch diameter shaft the opening may be 0.5156 inches for a close running fit and may be 0.5312 inches for a free running fit). Other clearance amounts are used for other clearance types. See “Engineering Fit” at: en.wikipedia.org/wiki/Engineering_fit; and “Three General Types of Fit,” available at mmto.org/˜dclark/Reports/Encoder %20Upgrade/fittolerences%20%5BRead-Only%5D.pdf.

It is further noted that any use herein of relative terms such as “top,” “bottom,” “upper,” “lower,” “vertical,” and “horizontal” are merely intended to be descriptive for the reader, and may be based on the depiction of those features within the figures for one particular position of the screen assembly, and such terms are not intended to limit the orientation with which the disclosed apparatus may be utilized.

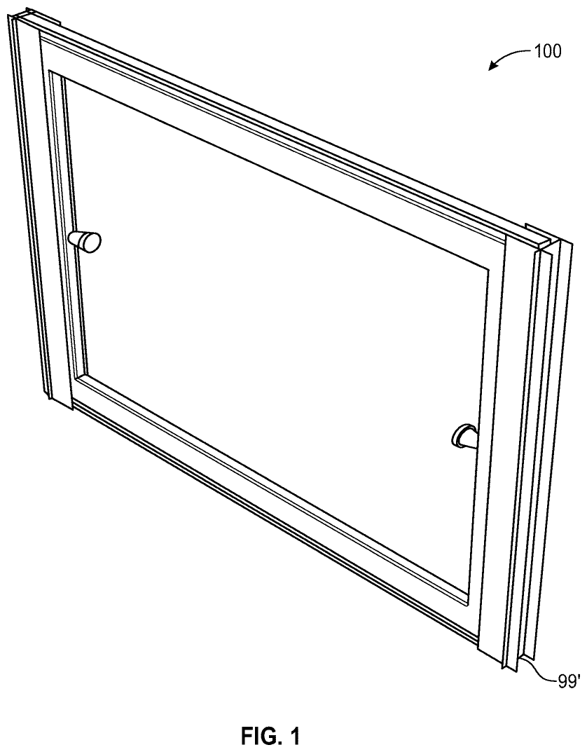

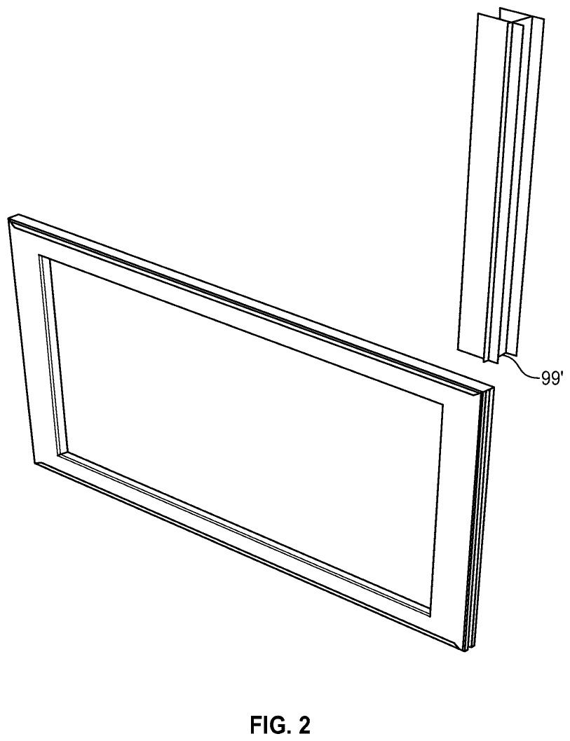

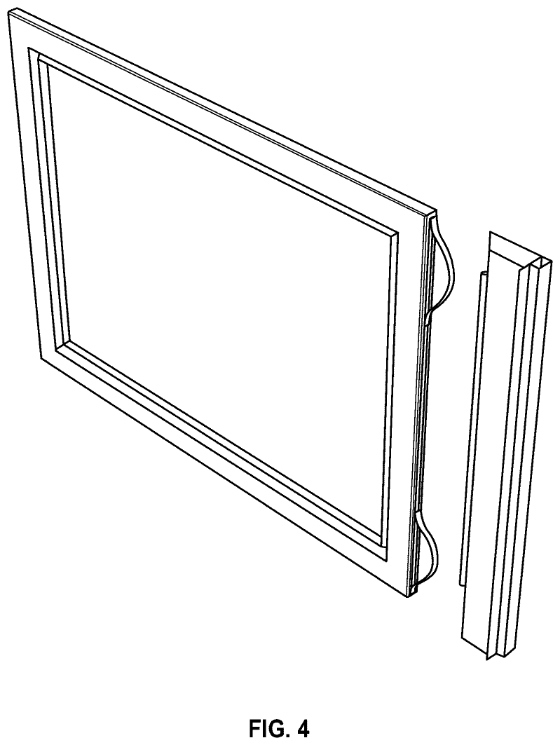

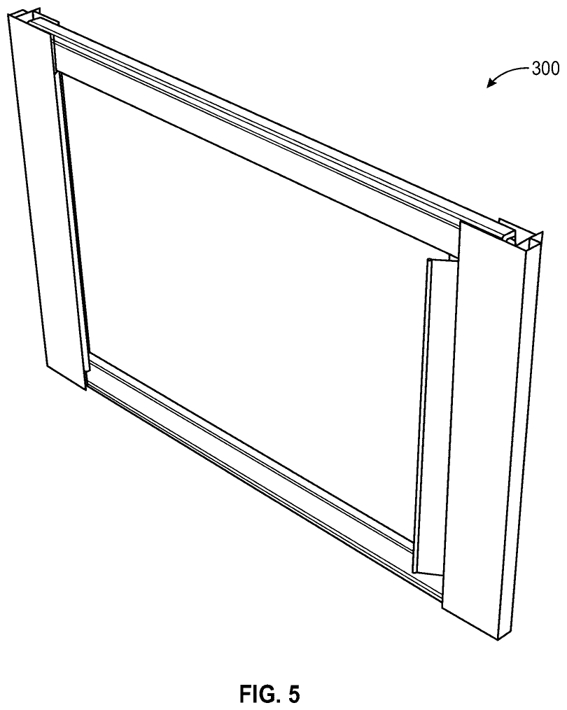

FIGS. 1, 3, 5, 11, and 17 illustrate the herein disclosed window screen assembly with one or more side expander members, which operates to reduce the number of different measurements and the accuracy of those measurements needed in order for a homeowner to select and obtain a screen for an old window, or a window that is missing a screen. Each of those versions of the screen assembly may use the same basic components, but may use different hardware that is grasped by the user to actuate the side expanders into a retracted position for installation into the window or removal therefrom.

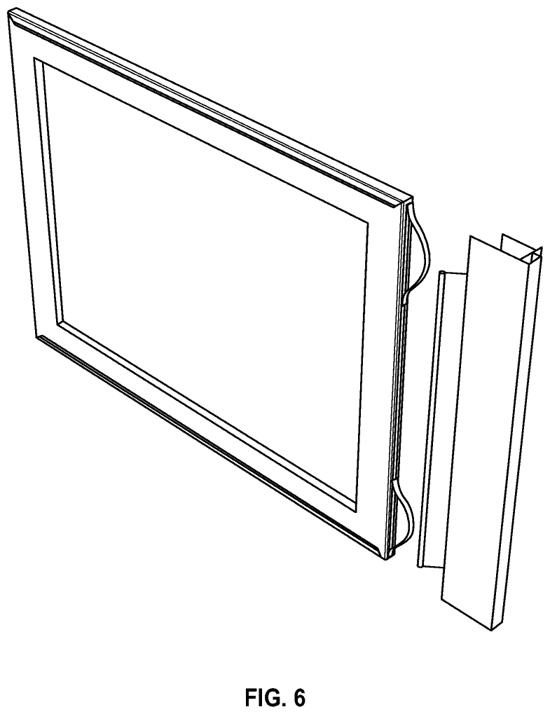

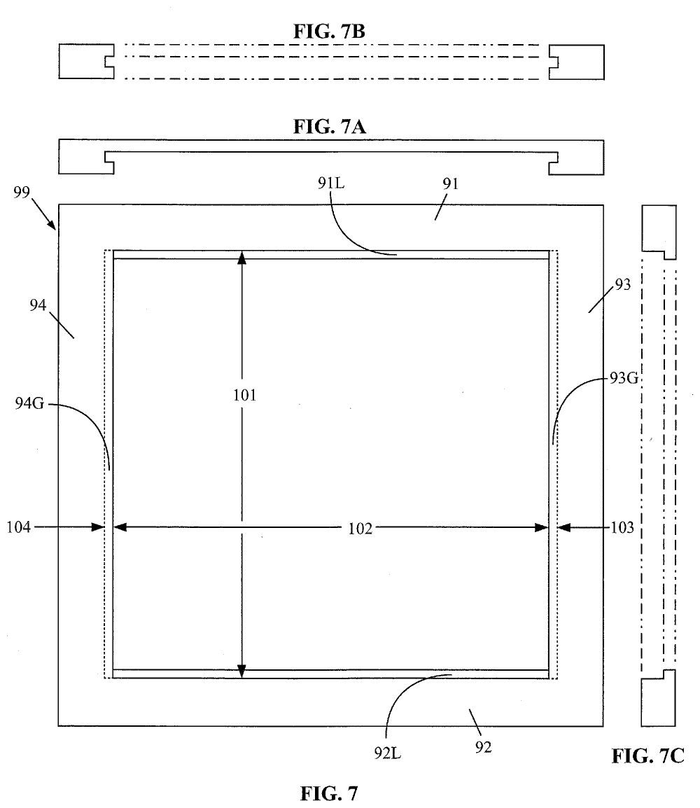

Windows are manufactured in many different styles, including, but not limited to: single hung windows, double hung windows, casement windows, awning windows, bay windows, jalousie windows, etc. Many of these types of windows accommodate installation of a screen, being either an exterior screen (used on a first floor window), or an interior screen that is installed from inside the building. Similarly, many doors, particularly a “screen/storm door,” accommodate installation of a screen (often by replacement of a storm window in the door with a screen). Therefore, there are many different cross-sectional shapes for these various fenestration products into which a screen may be installed. For example, a screen may be installed in a master frame of a window that holds a sliding sash window member, which sash member has its own frame, and which master window frame may appear to be very complicated to a homeowner needing to take measurements (see e.g., the prior art master window frame shown in FIG. 21). For the purpose of illustrating the functionality of the screen assemblies disclosed herein, a highly simplified master window frame is shown in the front view of FIG. 7, which may be referred to hereinafter simply as a “window frame,” with the understanding that the herein disclosed screen assembly may be utilized in any suitable fenestration product.

As seen in FIG. 7, FIG. 7A, and FIG. 7B, a window frame 99 may have an opening defining grooves 91G and 92G having respective landings 91L and 92L (i.e., the bottommost portion of the groove/socket, which may be planar) on first and second opposite sides (91, 92) of the window frame, with the extent of the landings being separated by a distance shown by the dimension 101. The opening in the frame may also define grooves 93G and 94G having respective landings 93L/94L on third and fourth opposite sides (93, 94) of the frame. The depth of grooves 93G and 94G is respectively shown by the dimensions 103 and 104, and with the opening at the beginning of those two grooves 93G and 94G being separated by a distance shown by the dimension 102.

When a homeowner needs to acquire a screen for the window frame 99 when a pre-existing screen is not available, and if working independently, he/she must necessarily measure the particular openings and obtain the measurements shown by dimensions 101, 102, 103, and 104. The screen acquired for the opening must be formed to have its extent in a first direction correspond to dimension 101, such that it is just incrementally smaller than what is measured, so that the screen will fit into the socket in that direction but not leave a gap that would permit insects to traverse through that gap into the interior of the dwelling. Acquiring measurement for dimension 101 may be straight-forward for many homeowners. However, what is probably more challenging for most homeowners to determine is the extent of the frame that needs to fit between the other two sides, which needs to be formed to be just incrementally smaller than the distance between landing 93L and landing 94L (i.e., it needs to be just smaller than the distance 102+103+104), in order for the frame of the screen to be retained within the grooves (93G, 94G), but also be formed such that the extent of the screen in that direction is larger than the dimension 102 (i.e., so as to not leave a gap in that direction as well). If the frame of the screen is to be securely held and resist being dislodged by slamming of the window or slamming of the screen door into which it may be installed, the extent of the screen in this direction should occupy as much of the groove depths as possible, while still permitting installation of the screen's frame into those two grooves.

The screen is typically installed by initially feeding a portion of a first end of its frame into one of the grooves (e.g., groove 93G), then pivoting the screen so that its frame may lay flush against the landings (91L, 92L), and finally by sliding the second end of the screen's frame into the other groove (i.e., groove 94G).

For the homeowner to select a screen at a store or have a screen manufactured for the opening in window 99 of an old existing window, which more than likely is not a common size, he/she needs to accurately measure the dimensions 102, 103, and 104, and also measure the dimension 101, which measurement-taking is a daunting task for most people.

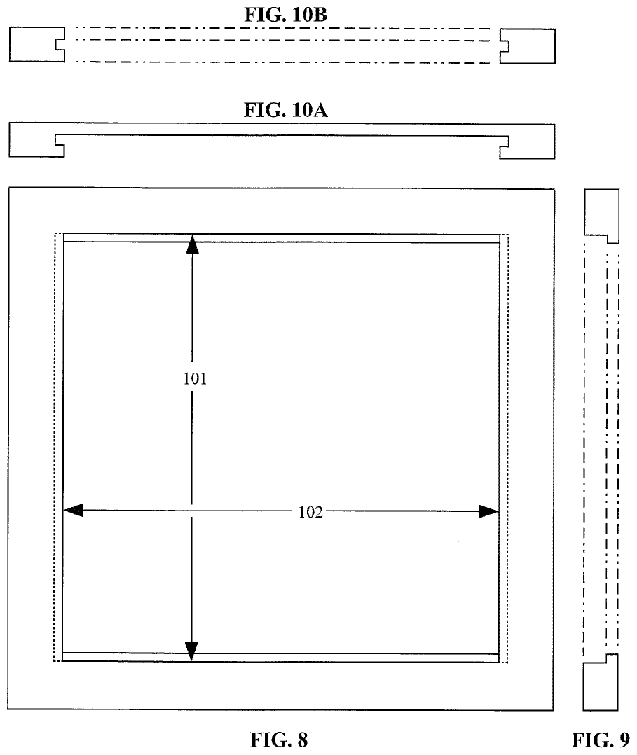

The herein disclosed screen assembly obviates the need for such accurate measurement taking, as the only two measurements that the do-it-yourself homeowner needs to acquire are dimensions 101 and 102, as seen in FIG. 8, and the accuracy is not critical.

The herein disclosed screen assembly overcomes that problem of needing to take accurate measurements through the use of at least one expander, and more preferably through the use of dual expanders, with one expander member on each side of the frame of the screen.

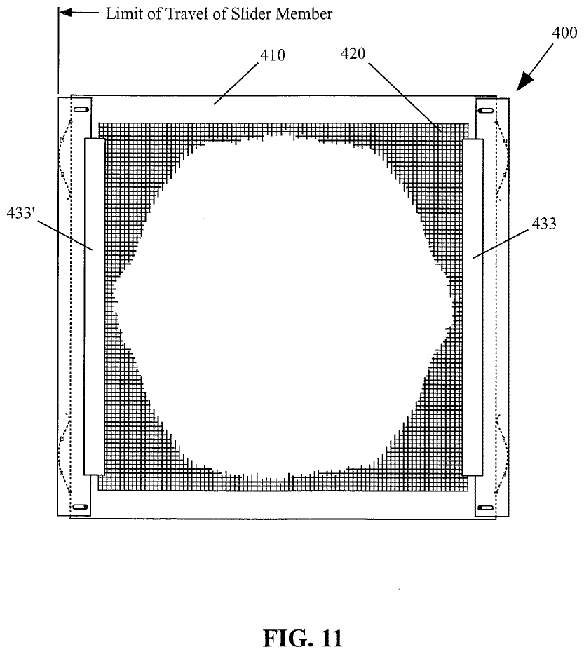

The screen assembly 400 shown in FIG. 11 is described hereinafter to be illustrative of the common aspects that may also be found in the screen assemblies 100, 200, and 300, shown in FIGS. 1, 3, and 5.

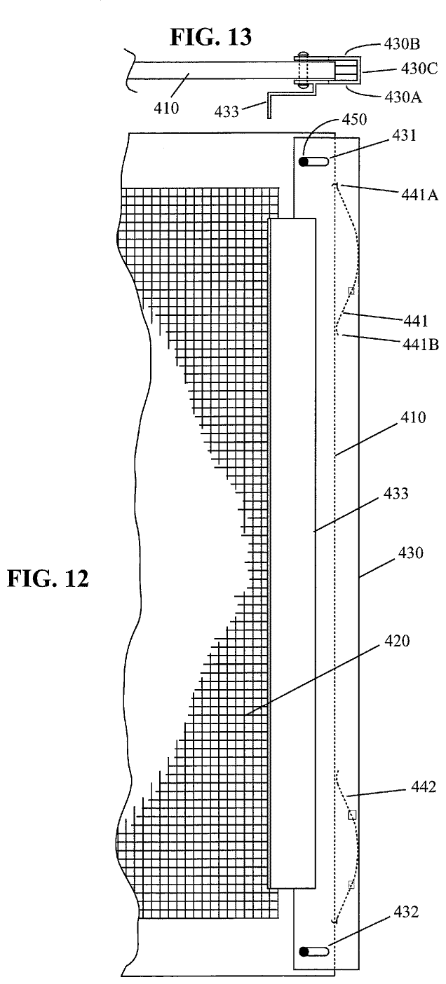

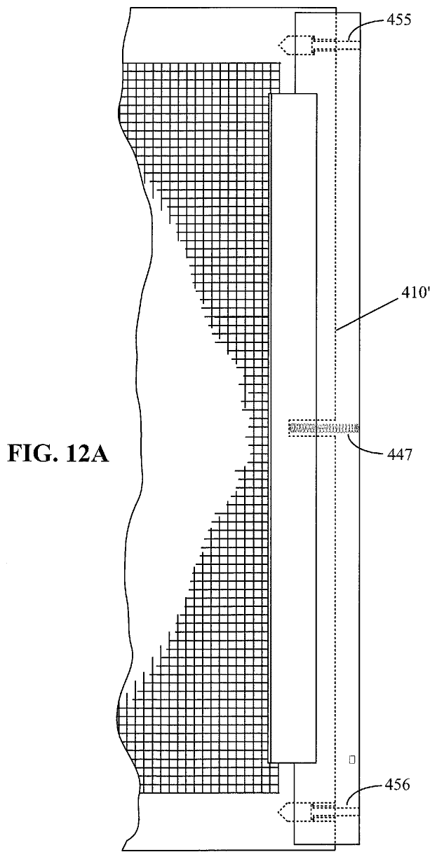

As seen in FIG. 11, the screen assembly 400 may include a frame 410, a piece of mesh material 420 that is secured to the frame, and preferably an expander subassembly on each of its left and right sides. The right side of the screen assembly 400 of FIG. 11 is shown enlarged in FIG. 12, and also in the top view of FIG. 13. (It is noted that the expander subassembly and a suitable biasing structure may be retrofit onto a pre-existing frame 410 to create the screen assembly 400).

As seen in FIG. 12, the expander subassembly may include an expander member 430, and at least one member that is configured to provide biasing. The expander subassembly may also include a track arrangement.

The expander member 430 may be formed to have a length such that it extends along the entire length of the adjacent side of the frame 410 (i.e., being coterminous therewith). Alternatively, as seen in FIG. 12, the expander member 430 may be formed to have a length that may be slightly shorter than the full length of the side of the frame 410. A handle 433 may protrude from one side of the expander member 430, which may be integrally formed with the expander or may be fastened thereto. The expander member 430 may be formed to have any suitable cross-sectional shape, as other shapes/arrangements for the expander subassembly other than what is illustrated are also contemplated herein.

As seen in FIG. 13, the expander member 430 may be formed as a channel section, and may have first and second legs (430A and 430B) that may be of equal length, which may be connected by a shorter third leg 430C. The dimensions of the cross-section of the channel used for the expander member 430 may be formed to slidably receive a portion of the frame 410 therein, which may be received in a slight clearance fit, or even a slight friction fit.

In one embodiment, to guide the desired sliding motion of the expander member 430 relative to the frame 410, a track arrangement may be utilized with respect to those two members. For example, as seen in FIG. 12, a first slotted opening 431 and a second slotted opening 432 may be formed in the leg 430A of the expander member, and corresponding openings may also be formed in the second leg 430B, which corresponding openings may be aligned with the openings in the first leg. One or more pins 450 may be used to slidably mount the expander member 430 relative to the frame 410 at each slotted opening that is utilized (note that while one slotted opening and pin combination being centered on the side of the frame between the two leaf springs may suitably provide for retention of the expander member 430 with respect to the frame 410, two or more would provide for smoother sliding motion therebetween). Any suitable pin may be used. In one embodiment, a bolt and nut may be used as the pin. In another embodiment, a bucket rivet may be used as the pin. In a further embodiment, a post and screw (i.e., a “sex bolt”) may be used as the pin. In yet another embodiment, a screw may be driven into the frame through each opening on each side of the expander member 430, where the screw is not torqued to the point of cinching the expander member against the frame, as a gap therebetween would permit the necessary sliding movement. Each screw would independently serve as a pin to enable the directed sliding movement of the expander member 430. It is noted that the arrangement may have only one side of the channel of the expander member pinned to support sliding movement; however, having both sides pinned as shown in FIG. 13 may further provide for more stable sliding movement, and as such may be preferable.

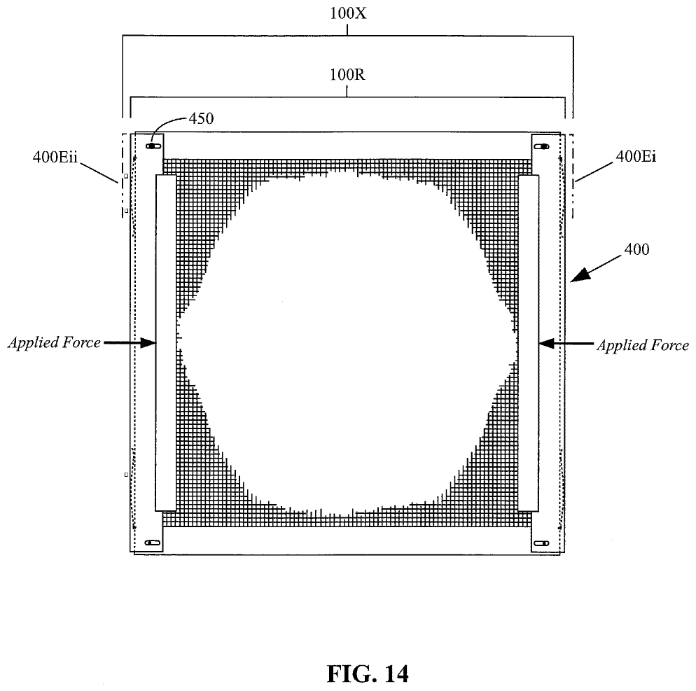

The length and positioning of the slotted openings 431/432 that are utilized may determine the limits of travel that the expander member 430 may experience, depending also upon the spring that is used (i.e., if the spring is configured to fully bias sliding movement of the expander member). The combination of the spring(s) utilized, the positioning of the first end of the slotted opening, and the location of pin 450 in FIG. 11 may result in the pin contacting the end of the opening to limit further biased sliding of the expander member, as indicated therein. As may be seen in FIG. 14, the second end of the slotted opening has not yet contacted the pin 450, and the spring is almost completely compressed, indicating that such total compression of the spring and bottoming out of the expander member with respect to the frame 410 may limit motion of the expander member in that direction; use of a shorter length for the slotted opening, i.e., positioning the right end of the slotted opening further to the left, may instead limit travel of the expander member before bottoming out of the spring occurs, which may be preferable.

Any suitable device that is capable of providing bias may be used, e.g., a charged hydraulic/pneumatic cylinder/actuator, springs, etc. In one embodiment, a single biasing device may be used to provide the biasing, and in another embodiment, two or more biasing devices may be used. A spring, where utilized, may be any suitable spring known in the art, including, but not limited to: a leaf spring, a compression spring, a torsion spring, etc. Merely to be exemplary, two leaf springs (441 and 442) are shown in the arrangement of FIG. 12. The leaf springs (441 and 442) may have a first end 441A secured to the side of the frame 401, and the second end 441B may be disposed in proximity to the side of the frame, but may not being attached thereto, such that it can extend along the side of the frame when compressed. The second end 441B of the spring 441 may curve away from the frame, to permit ease of sliding movement with respect to the side of the frame, and to ensure that it does not gouge the frame when actuated over many cycles, which may tend to diminish the structural integrity of frame 410. The second end 441B of the spring 441 may alternatively be coupled to the side of the frame to slide along that side, e.g., the second end of the spring may have a pin that is configured to slide in a track formed in or added to the side of the frame 410 (not shown), or the second end of the spring may have a slotted opening that tracks along a protruding pin on the frame, etc.

In an arrangement where a single spring is utilized, it may preferably be disposed proximate to the mid-point of the length of the side of the frame 410, as being so positioned may result in less of a tendency of the expander member 430 to bind with respect to the frame 410.

As seen in FIG. 11, the expander subassembly on the left side of the screen assembly 400 may be the mirror image arrangement of the expander subassembly used on the right side, together providing handles 433 and 433′.

As may be understood from comparing the screen assembly 400 shown in FIG. 11 with its appearance in FIG. 14, when the user applies a force to the handles 433 and 433′ in the direction indicated by the arrows it will cause the expander members to deform the biasing members to be as shown in FIG. 14. Application of the force by a user to the dual expanders as shown may position each in a fully retracted position, and in which position the springs are compressed and store spring energy. When the user releases the force from the handles 433 and 433′, the energy stored by the biasing member(s), e.g., the springs, causes them to return to the unbiased (fully extended) position, which biases the expander members from the positions shown in FIG. 14 back to the extended positions shown in FIG. 11, which extended positions are indicated in FIG. 14 using the phantom lines 400Ei and 400Eii. As seen in FIG. 14, the difference between the distance 100R between the outer sides of the extender members when in the retracted position, versus the maximum distance 100X when released and in the extended position (i.e., lines 400Ei and 400Eii) is roughly indicative of the range of window size openings that may be accommodated by that particular screen assembly. It is only indicative because some portion of the distal ends of each extender member is needed for engagement within the respective sockets of the window (or door). The larger the springs used in conjunction with longer slotted openings 431/432, the greater will be the range of different window openings that may be accommodated by that screen assembly. Merely to be exemplary, in one embodiment, the size of the springs used and the particular length used for the slotted openings 431/432 may be configured to accommodate a one inch range of different openings. As described, other ranges of openings may similarly be provided by varying of the above-noted parameters.

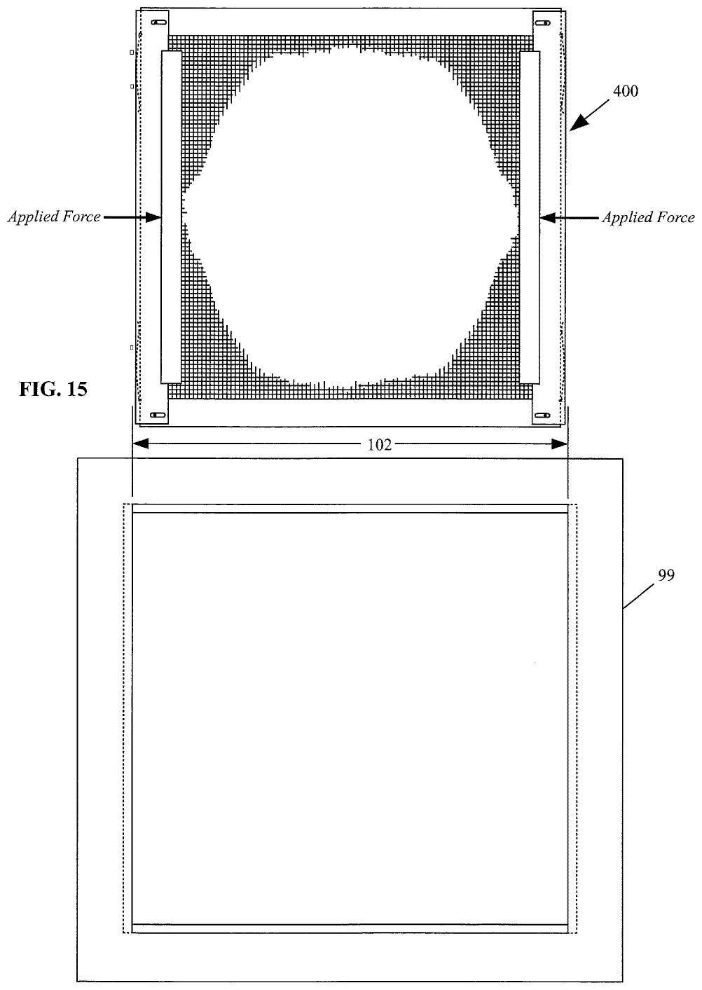

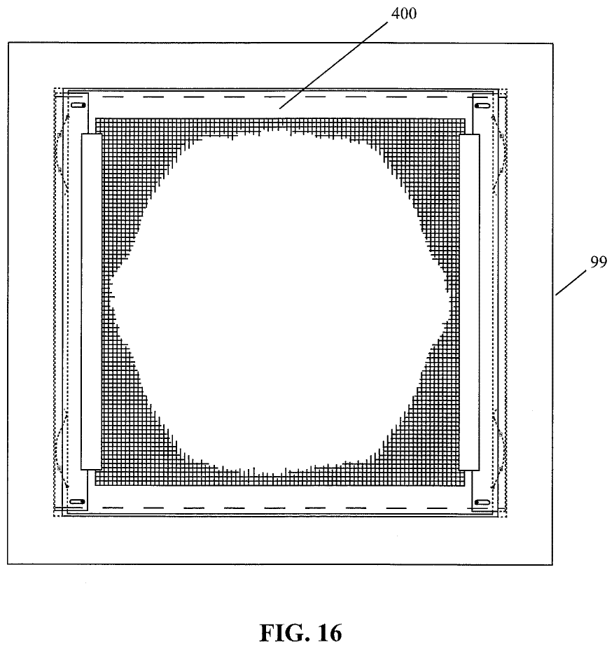

FIG. 15 shows the screen assembly 400 of FIG. 14 just prior to being installed in the window frame 99 of FIG. 8, where both expander members have been actuated by a force into the respective retracted positions; and FIG. 16 shows the screen assembly of FIG. 11 after being installed in the master window frame of FIG. 8.

The screen assembly 100 shown in FIG. 1 may be formed the same as the screen assembly 400, except that each expander member may have a plunger handle disposed perpendicularly away from the inner side of the screen's frame.

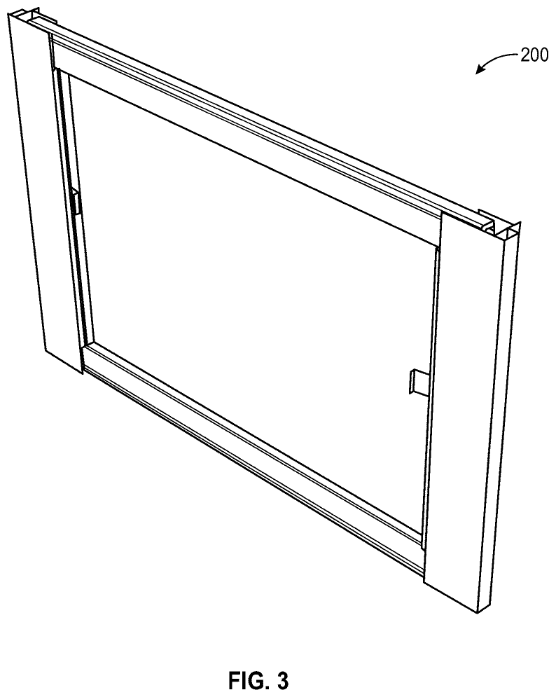

The screen assembly 200 shown in FIG. 3 may be formed the same as the screen assembly 400, except that each expander member may have a small pull-tab as the handle to actuate the expander away from the window frame 99′.

The screen assembly 300 shown in FIG. 3 may be formed the same as the screen assembly 400, except that only one expander member may have a handle thereon.

FIG. 12A is the detail view of FIG. 12, but which instead illustrates use of a helical compression spring 447 for biasing of the expander member. In addition, FIG. 12A shows the use of a dowel pin 455 that extends away from and protrudes into the channel section of the expander member. The dowel pin is configured to be received in a corresponding opening in the side of the frame 410′. To limit the biased movement of the expander member, the dowel pin 455 may have a head with a slightly larger diameter, which may contact a shoulder formed in the opening in the frame, as shown for the upper dowel pin in FIG. 12A. Alternatively, a bushing may be press fit into the opening in the frame to provide the shoulder, as shown for the lower dowel pin 456 in FIG. 12A.

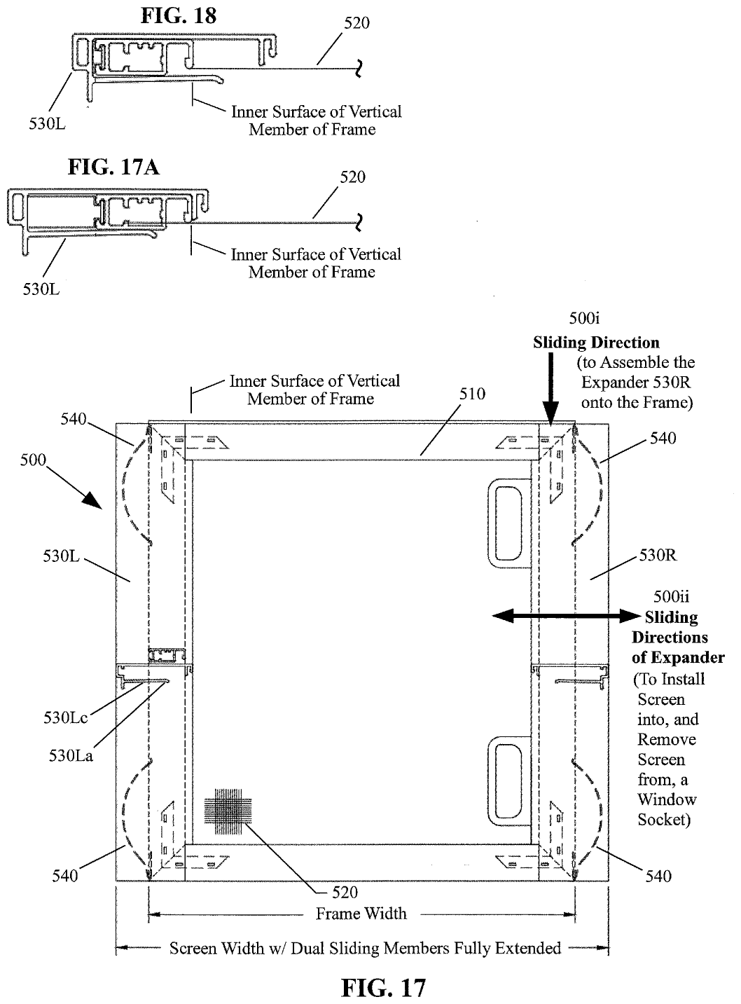

The screen assembly 500 shown in FIG. 17 is formed similar to the screen assembly 400 shown in FIG. 11, but utilizes a different arrangement for mounting of the expander member to the frame, which also thereby serves to limit the extent to which it may be outwardly biased.

As seen in FIG. 17, the screen assembly 500 may include a frame 510, a piece of mesh material 520 that is secured to the frame, at least one expander member being slidably mounted to its left or right sides, and one or more springs 540 configured to bias each expander member into a fully extended position. FIG. 17 shows an expander member 530L mounted to the left side of the frame 510 and an expander member 530R mounted to the right side of the frame, with each expander member being biased by two leaf springs. Each expander member 530L and/or 530R that is utilized may be configured to slidably mount to the frame 510 in a first direction 500i, which in one embodiment may be perpendicular to the axial direction 500ii that it may be configured to slide when actuated to oppose the spring biasing or when being biased by the spring(s), during installation into or removal from the master frame of the window.

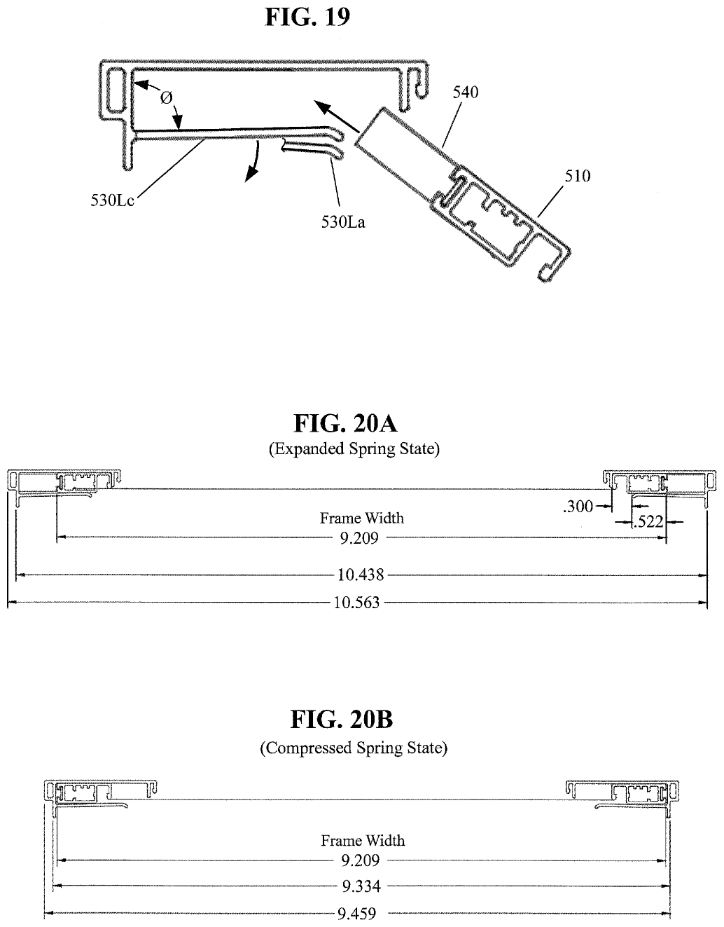

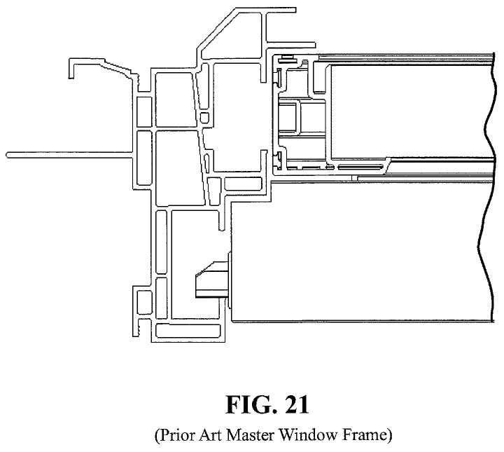

In another embodiment, the mounting direction may be generally as shown in FIG. 19 (i.e., in the same plane as the sliding direction for installation of the screen assembly), which may be accomplished by using a cross-section for the expander that is not a closed shape, and which instead may have one side 530Lc that is cantilevered and falls short of the adjacent side to create an opening. The one side 530Lc may be cantilevered and may act like a spring clip. The one side 530Lc may also terminate in an curved/angled portion 530La, which may better facilitate deflection of the cantilevered side and sliding of the frame through that opening to be retained within the cross-section of the expander member, as seen in FIG. 19.

A cross-sectional view of the left side of the screen assembly 500 of FIG. 17 is shown enlarged in FIG. 17A and FIG. 18. FIG. 17A is a cross-sectional view shown with the expander 530L in the fully extended position. FIG. 18 is a cross-sectional view shown with the expander 530L in the fully retracted position.

It is noted that use of the herein described expander assemblies on all four sides of the frame of the screen is also contemplated, as they may be configured to travel without interfering with each other, by being positioned at different levels, or by having the ends of each expander member formed at a 45-degree angle, with sufficient gaps formed therebetween.

While illustrative implementations of one or more embodiments of the disclosed system are provided hereinabove, those skilled in the art and having the benefit of the present disclosure will appreciate that further embodiments may be implemented with various changes within the scope of the disclosed system. Other modifications, substitutions, omissions and changes may be made in the design, size, materials used or proportions, operating conditions, assembly sequence, or arrangement or positioning of elements and members of the exemplary embodiments without departing from the spirit of this invention.

Accordingly, the breadth and scope of the present disclosure should not be limited by any of the above-described example embodiments, but should be defined only in accordance with the following claims and their equivalents.

1. A screen assembly, said screen assembly comprising:
a frame;
a mesh, said mesh being secured to said frame;
an expander member, said expander member being mounted to a first side of said frame, and configured to slide with respect to said frame between a fully retracted position, a fully extended position, and a plurality of intermediate positions between said fully retracted position and said fully expanded position;
at least one spring, said at least one spring configured to bias said expander member toward said fully extended position;
wherein a lateral distance across said screen assembly from a second side of said frame to a distal side of said expander member frame, when said expander member is in said fully retracted position, permits placement of said screen assembly into a window socket of a master window frame and wherein said first expander comprises a spring clip adapted to receive a portion of the frame; and
wherein a lateral distance across said screen assembly from said second side of said frame to said distal side of said expander member frame, when said expander member is thereafter biased into one of said plurality of intermediate positions, permits insertion and retention of at least a portion of said expander member in a first side of said window socket and insertion and retention of said second side of said frame in a second side of the window socket.
